(19) United States
(12) Patent Application Publication
(10) Pub. No.: US 2010/0173693 A1
(43) Pub. Date: Jul. 8, 2010

(54) GAMING MACHINE WITH RANDOM DISPLAY FIELD SYMBOL POPULATION

(75) Inventor: Gerard Crosby, South Hurstville (AU)

Correspondence Address: STETINA BRUNDA GARRED & BRUCKER, 75 ENTERPRISE, SUITE 250, ALISO VIEJO, CA, 92656, US

(73) Assignee: Konami Australia Pty. Ltd., Botnay (AU)

(21) Appl. No.: 12/684,001

(22) Filed: Jan. 7, 2010

(30) Foreign Application Priority Data
Jan. 8, 2009 (AU) AU2009200081

(51) Int. Cl. A63F 13/00

(52) U.S. Cl. 463/18

(57) ABSTRACT

A gaming machine including a display for display of symbols; said machine causing said symbols to be displayed in an array of fields; said array of fields in the form of substantially vertically aligned fields and substantially horizontally aligned fields; said symbols selected from a pool of n symbols for populating said array of fields according to the following steps:
a. random selection of a first symbol from said pool of n symbols,
b. repeating said random selection i times so as to select i+1 symbols from said pool of symbols where n≧i+1,
c. populating at random at least one column of said array of fields with said i+1 symbols.

### STATEMENT RE: FEDERALLY SPONSORED RESEARCH/DEVELOPMENT

Not Applicable

### BACKGROUND

Gaming, or poker machines, have become a major source of amusement and diversion in such places as clubs, hotels and casinos in many parts of the world.

Traditionally, such machines were mechanical devices where a number of reels marked with a plurality of numbers or symbols could be made to spin randomly by the application of some mechanical input. If the subsequent patterns of numbers or symbols displayed on the reels, when these returned to a rest state, corresponded to predetermined patterns, the machine would provide a prize or payout. Generally such gaming machines have come to be regulated by government authorities as to their number and in the manner in which the machines must return a percentage of the monetary turnover to the players.

The introduction of electronics, computers and electronic graphical displays, has allowed a continual increase in the complexity and variations of gaming machines, games and displays while maintaining at least some of the basic concepts of the traditional machine.

Machines and games that offer novel and stimulating variations on the basic game theme and environment are eagerly sought by the gaming industry and there is consequently intense competition between machine manufacturers to innovate.

Nevertheless the repetitive playing of even modern gaming machines can lead to boredom of the players with a consequent under-utilization of machines and increase in player dissatisfaction.

It is an object of the present invention to address or at least ameliorate some of the above disadvantages.

Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### BRIEF SUMMARY

Accordingly, in a first broad form of the invention, there is provided a gaming machine including a display for display of symbols; said machine causing said symbols to be displayed in an array of fields; said array of fields in the form of substantially vertically aligned fields and substantially horizontally aligned fields; said symbols selected from a pool of n symbols for populating said array of fields according to the following steps:

random selection of a first symbol from said pool of n symbols,

repeating said random selection i times so as to select i+1 symbols from said pool of symbols where n≧i+1,

populating at random at least one column of said array of fields with said i+1 symbols.

Preferably, said pool of symbols comprises a number of sets of like symbols.

Preferably, each like symbol within a said set of like symbols is differentiated by an assigned probability value.

Preferably, a selection of said i+1 symbols is made for each column of said array of fields.

Preferably, each time a selection step is repeated and a symbol selected from one of said sets of like symbols, that set of like symbols is removed from said pool of n symbols.

Preferably, a total number of selected symbols from said pool of symbols for populating said field of symbols is Σ₁₋ₓ(i+1), where X is the number of columns in said array of fields.

Preferably, fields of said array of fields are populated from said selected symbols in a random sequence.

Preferably, said array of fields comprises a combination of columns containing y fields and y+1 fields.

Preferably, said array of fields comprises an alternating sequence of y+1 field columns and y field columns.

Preferably, said array of fields comprises an alternating sequence of y field columns and y+1 field columns.

Preferably, said array of fields comprises a sequence of a first two columns of y+1 fields, a central column of y fields and a last two columns y+1 fields.

Preferably, y is an integer number between 3 and 5.

Preferably, said fields are in the form of a generally elongated lozenge shaped field.

Preferably, adjacent columns of said lozenge shaped fields are staggered vertically relative to one another, so as to allow a nested meshing of adjacent ends of said fields of respective said adjacent columns.

In another broad form of the invention, there is provided a method of populating an array of fields in a display of a gaming machine; said method including the steps of:

programming a game controller of said gaming machine to select symbols from a pool of symbols,

randomly populating fields of said array of fields with selected ones of said symbols,

wherein at each selection of a symbol, like symbols of said selected symbols are removed from said pool of symbols.

Preferably, said pool of symbols is comprised of sets of like symbols; like symbols within each said set of like symbols differentiated by assigned probability values.

Preferably, said array of fields is comprised of a number of columns of fields; at least some of said columns of said array varying in the number of fields by at least one field.

Preferably, a selection from said pool of symbols is made for each of said columns; the number of symbols selected equal to the number of fields in said column.

Preferably, said fields are of a generally lozenge shape; said lozenge shape adapted for a meshing of fields of adjoining columns when said adjoining columns are staggered vertically relative one to another.

### BRIEF DESCRIPTION OF THE DRAWINGS

Embodiments of the present invention will now be described with reference to the accompanying drawings wherein:

FIG. 1 is a front view of a gaming machine according to a preferred embodiment of the invention,

FIG. 2 is an example of a display of an array of fields populated with symbols for display on the gaming machine of FIG. 1,

FIG. 3 is a representation of a pool of symbols from which the symbols for populating the array of fields of FIG. 2,

FIG. 4 is illustrative of a selection sequence for determining the symbols for the population of the array of fields of FIG. 2,

FIGS. 5A to 5C are examples of preferred arrays of the symbol containing fields of FIG. 2,

FIG. 6 is a schematic representation of the main electronic components of the gaming machine of FIG. 1.

### DETAILED DESCRIPTION

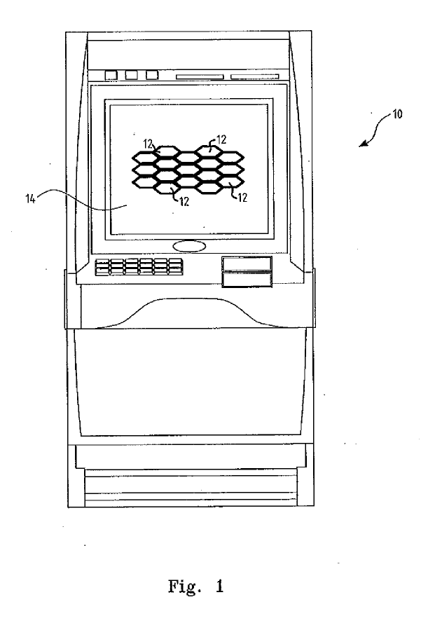

According to the present invention, a gaming machine 10 such as shown in FIG. 1, is arranged for play of a game of chance based on configurations of a patterns of symbols arranged in fields 12 displayed on a display portion 14 of the machine 10.

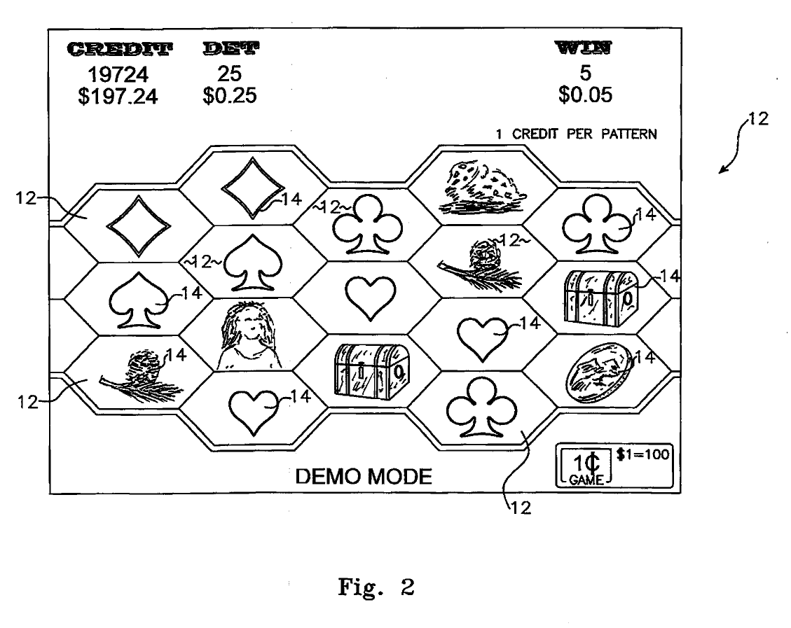

In the present invention, the fields 12 do not form part of simulated reels and no rotation or other displacement of the fields during the progress of a game occurs. However, the particular arrangement of the fields or their shape need not be the same for all games and may vary from one game to another, for example as a function of volume of play on the machine or according to some other variable. Preferably, the fields are arranged as substantially vertically aligned fields and substantially horizontally aligned fields. Preferably also, the substantially vertically aligned fields form columns of fields as shown in FIG. 2.

A particular feature of the gaming machine of the present invention is the manner in which symbols 14 are selected and in the way the fields 12 of the display are populated with the symbols derived through the selection process.

A number of different symbols 14, such as are typical of reel type games played on gaming machines, comprises a pool of n symbols. The pool of n symbols in turn is comprised of a number of sets of like symbols, such as shown for example in FIG. 3, in which the letters represent either a letter, a numeral or some interesting graphic such as the examples shown in FIG. 2. Thus, by way of example, one set may include a number of instances of the graphic depicting a treasure chest, while another set may comprise a number of instances of a playing card symbol. The number of instances of symbols within the sets of symbols, need not be the same for each set, as illustrated by the pool of n symbols 16 of FIG. 3. Within a set, the like symbols are differentiated by an assigned probability value. This probability value may be used to determine a game outcome, should the symbol be selected for inclusion in the symbol population of a game.

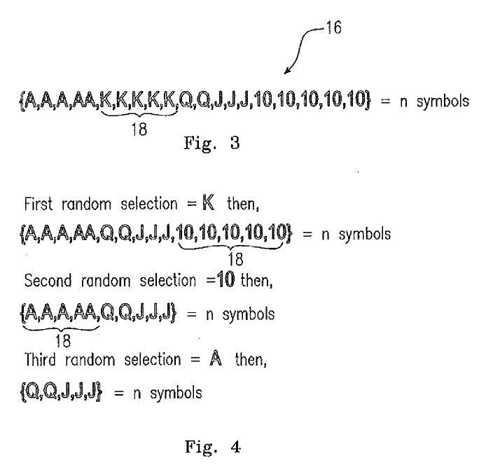

With reference to FIG. 4, the process of selection is executed by a programmed game controller as follows. A first symbol is selected from the pool of n symbols 16, for example a symbol represented by the letter “K”. The set of like symbols 18, in this example the Ks, from which this first symbol was selected is then removed from the pool. A next symbol is selected, again at random, from the remaining symbols of the pool, for example a symbol represented by the numeral “10”, and again that set of like symbols 20 from which this next selection was made, is removed from the pool. If the number of iterations of selections, after selection of the first symbol, is “i” then the number of selected symbols at the end of a selection sequence may be given as i+1, where n≧i+1. Thus in the example illustrated in FIG. 4, after the first selection of the symbol represented by K, there are two further iterations, so that i=2 and the number of selected symbols is i+1=3.

Preferably i+1=Y, where Y is the number of fields in a column, and the selection process thus selects for each column, from the pool of n symbols, the number of symbols required to place a symbol in each field of the column. Again, referring to the example of FIG. 4, the three symbols selected may be used to randomly populate the three fields 12 of the first left hand column shown in FIG. 2. The total number of selected symbols from the pool of n symbols for populating all the fields of the display with symbols is then Σ₁₋ₓ(i+1), where X is the number of columns in the array of fields.

Once the selection of symbols process described above is completed for a new game being played on the machine, the fields of the display are populated at random by the selected symbols. Preferably the populating of the fields takes place sequentially, so that a first symbol “pops” into view in a first randomly selected field and then a second symbol in a next randomly selected field, and so on until all the fields are populated.

As shown in FIG. 2, the number of fields 12 in each column needs not be equal, and preferably, the number of fields in any column may be in the range of three to five. Preferably the array of fields comprises a combination of columns containing y fields and columns containing y+1 fields, where y is an integer equal to two, three or four.

Again, preferably though not necessarily, the fields are of a general elongated lozenge shape such as shown in FIG. 2. Adjoining columns may be staggered vertically relative to one another to allow a nested meshing of adjacent ends of the fields 12 of the respective adjacent columns.

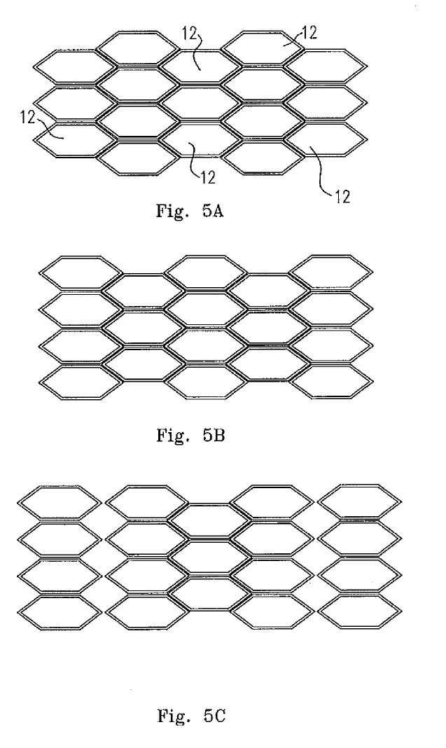

Examples of preferred arrangements of fields and columns are shown in FIGS. 5A to 5C. Thus in FIG. 5A, the field comprises an alternating sequence of y field columns and y+1 field columns, (the arrangement of FIG. 2), while FIG. 5B shows an alternating sequence of y field columns and y+1 field columns. FIG. 5C shows an array of fields comprising a sequence of a first two columns of y+1 fields, a central column of y fields and a last two columns y+1 fields.

In Use

In use, a winning outcome of a game according to the gaming machine of the present invention, may be determined in similar manner to that of conventional spinning reel type games. That is a predefined pattern of symbols coinciding with predefined one or more pay lines may define a winning outcome. As with other known games, special symbols may be included, such as scatter symbols to which attach particular outcome winning properties.

Game Implementation

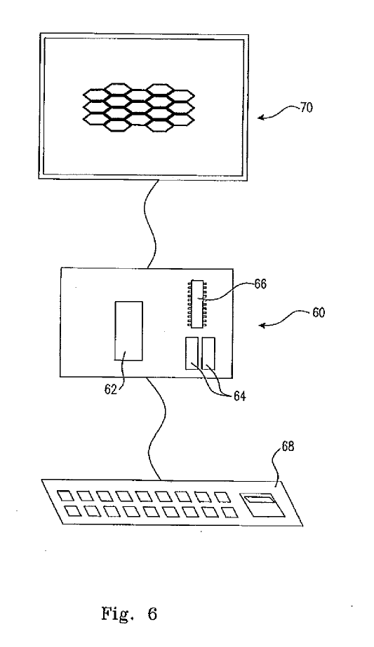

Any of the above described embodiments may be implemented on any gaming machine or group of gaming machine provided with a control module. As shown in FIG. 6, a control module 60 is provided with a microprocessor 62 and working random access memory (RAM) 64. The program code driving any of the described embodiments may be introduced into the control module 60 by connection of a data storage device 66. The device may take any of a number of forms, such as read only memory (ROM), erasable read only memory (EPROM), Compact Flash Card, PCMCIA card and the like. Alternatively, control module 60 may incorporate a hard disc drive to which the code may be written via a suitable input device.

Control module 60 acts to implement appropriate elements of the program code according to inputs from a user keyboard 68 and outputs video imagery to at least a main display module 70.

The description above describes only some embodiments of the present invention and modifications, obvious to those skilled in the art, can be made thereto without departing from the scope and spirit of the present invention.

What is claimed is:

1. A gaming machine including a display for display of symbols; said machine causing said symbols to be displayed in an array of fields; said array of fields in the form of substantially vertically aligned fields and substantially horizontally aligned fields; said symbols selected from a pool of n symbols for populating said array of fields according to the following steps:
a. random selection of a first symbol from said pool of n symbols,
b. repeating said random selection i times so as to select i+1 symbols from said pool of symbols where n≧i+1,
c. populating at random at least one column of said array of fields with said i+1 symbols.

2. The machine of claim 1, wherein said pool of symbols comprises a number of sets of like symbols.

3. The machine of claim 1, wherein each like symbol within a said set of like symbols is differentiated by an assigned probability value.

4. The machine of claim 1, wherein a selection of said i+1 symbols is made for each column of said array of fields.

5. The machine of claim 4, wherein each time a selection step is repeated and a symbol selected from one of said sets of like symbols, that set of like symbols is removed from said pool of n symbols.

6. The machine of claim 1, wherein a total number of selected symbols from said pool of symbols for populating said field of symbols is Σ_{1-X}(i+1), where X is the number of columns in said array of fields.

7. The machine of claim 1, wherein fields of said array of fields are populated from said selected symbols in a random sequence.

8. The machine of claim 1, wherein said array of fields comprises a combination of columns containing y fields and y+1 fields.

9. The machine of claim 8, wherein said array of fields comprises an alternating sequence of y+1 field columns and y field columns.

10. The machine of claim 8, wherein said array of fields comprises an alternating sequence of y field columns and y+1 field columns.

11. The machine of claim 8, wherein said array of fields comprises a sequence of a first two columns of y+1 fields, a central column of y fields and a last two columns y+1 fields.

12. The machine of claim 8, wherein y is an integer number between 3 and 5.

13. The machine of claim 1, wherein said fields are in the form of a generally elongated lozenge shaped field.

14. The machine of claim 13, wherein adjacent columns of said lozenge shaped fields are staggered vertically relative to one another, so as to allow a nested meshing of adjacent ends of said fields of respective said adjacent columns.

15. A method of populating an array of fields in a display of a gaming machine, said method including the steps of:
a. programming a game controller of said gaming machine to select symbols from a pool of symbols,
b. randomly populating fields of said array of fields with selected ones of said symbols,
wherein at each selection of a symbol, like symbols of said selected symbols are removed from said pool of symbols.

16. The method of claim 15, wherein said pool of symbols is comprised of sets of like symbols; like symbols within each said set of like symbols differentiated by assigned probability values.

17. The method of claim 15, wherein said array of fields is comprised of a number of columns of fields; at least some of said columns of said array varying in the number of fields by at least one field.

18. The method of claim 17, wherein a selection from said pool of symbols is made for each of said columns; the number of symbols selected equal to the number of fields in said column.

19. The method of claim 15, wherein said fields are of a generally lozenge shape; said lozenge shape adapted for a meshing of fields of adjoining columns when said adjoining columns are staggered vertically relative one to another.
